(19) United States
(12) Patent Application Publication
(10) Pub. No.: US 2003/0050810 A1
(43) Pub. Date: Mar. 13, 2003

(54) Method of evaluating shipping costs using a benchmark cost

(76) Inventor: William B. Larkin, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/949,496

(22) Filed: Sep. 7, 2001

(51) Int. Cl. G06F 17/60

(52) U.S. Cl. 705/7

(57) ABSTRACT

A method of comparing the total cost for a plurality of actual shipments by a first shipper to the total cost for a plurality of actual shipments by a second shipper. The method includes compiling data for the plurality of actual shipments by the first shipper including actual shipment cost and compiling data for the plurality of actual shipments by the second shipper including actual shipment cost. A plurality of benchmark cost factors are compiled that are proportional to various aircraft costs per mile to determine a benchmark cost for each shipment. A deviation between the actual cost and the benchmark cost for each shipment is determined and the deviations are summed to provide a first and second shipper average deviation. The average deviations are then compared to determine which of the shippers experienced the lowest shipping expense.

### FIELD OF THE INVENTION

The subject invention relates to a method of comparing actual shipping costs between two independent shippers.

### BACKGROUND OF THE INVENTION

Many shipping companies perform statistical analyses to determine the economies of their services. For instance, an aircraft shipper will conduct periodic reviews of past shipments to determine whether or not the past shipments have been profitable for the company. An actual cost charged by the shipper for each shipment is compared to available costs using various aircraft of different load carrying capacities.

However, there remains a need for a method to compare the total costs of a plurality of shipments by a first shipper to the total costs of a plurality of shipments by a second shipper to determine which shipper experienced the lowest shipping expense. The difficulty with comparing the first shipper and the second shipper is the improbability that both the shippers will have an identical plurality of shipments to compare with each other to provide an “apples to apples” comparison. The plurality of shipments for the first shipper and the plurality of shipments for the second shipper have few similarities in weight of the goods shipped and distance traveled.

### SUMMARY OF THE INVENTION AND ADVANTAGES

The present invention provides a method of comparing the total cost for a plurality of actual shipments by a first shipper to the total cost for a plurality of actual shipments by a second shipper. In the method, data is compiled for the plurality of actual shipments by the first shipper including actual shipment cost. Data is also compiled for the plurality of actual shipments by the second shipper including actual shipment cost. A plurality of benchmark cost factors are compiled that are proportional to at least a portion of the data. The benchmark cost factor which is proportional to the actual shipment data is used to determine a benchmark cost for each shipment. A deviation between the actual cost for each shipment and the benchmark cost for each shipment is determined. The deviations are summed together to provide a first shipper average deviation and a second shipper average deviation. The average deviations are compared to determine which of the first and second shippers experienced the lowest shipping expense.

The subjection invention overcomes the difficulties of the prior art methods by providing a universal benchmark cost that allows an entity to compare the total cost for the plurality of shipments by the first shipper to the total cost for the plurality of shipments by the second shipper. The subject invention provides for such a comparison in the absence of an “apples to apples” relationship. As a result, the entity shopping for a new shipping service can compare a number of shippers by calculating the average deviation for each shipper and comparing the average deviations to determine which shipper has the lowest shipping expense. This is particularly useful for aircraft shipping services that are trying to market their services to potential clients. The potential clients can review their actual costs for shipments to the benchmark costs and compare how their current service measures up to the competing service.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an illustration of an aircraft rate schedule used to determine a benchmark cost.

FIG. 2 is an illustration of a chart of benchmark rate factors used to determine the benchmark cost.

FIG. 3 is an illustration of a first shipper chart of compiled data from a plurality of shipments by a first shipper.

FIG. 4 is an illustration of a second shipper chart of compiled data from a plurality of shipments by a second shipper.

### DETAILED DESCRIPTION OF THE PREFERRED EMBODIMENT

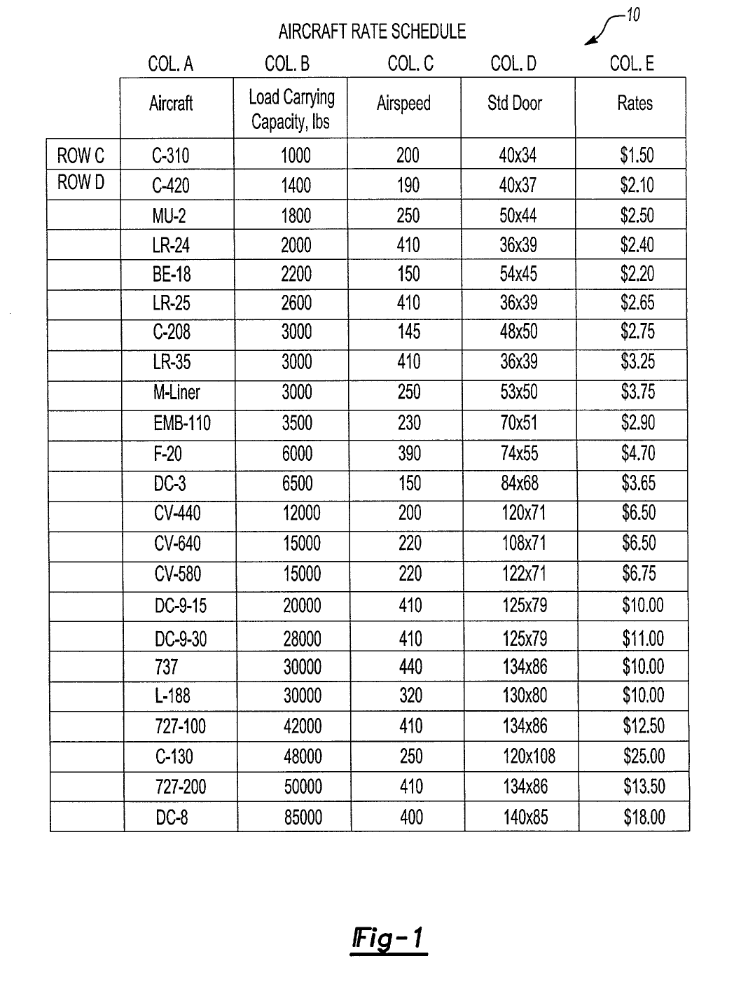

Referring to the Figures, wherein like numerals indicate like or corresponding parts throughout the several views and COL. refers to a COLUMN, a method of comparing the total cost for a plurality of actual shipments by a first shipper to the total cost for a plurality of actual shipments by a second shipper is generally shown in FIGS. 1 through 4. The present invention may be used to compare shipping costs for any type of shipping service including, but not limited to, ground shipping by way of truck or freight train, waterway shipping by way of freighters, or air shipping by way of aircraft. Therefore, the type of shipping service using the present invention is not intended to limit the present invention. For illustrative purposes only, shipping by way of aircraft will be discussed.

In the preferred embodiment of the present invention, an aircraft rate schedule 10 is prepared by compiling a list of aircraft COL. A serially arranged by load carrying capacity COL. B. The aircraft rate schedule 10 lists a variety of parameters attributed to each aircraft COL. A such as airspeed COL. C, standard door size COL. D, and cost per mile COL. E. The cost per mile COL. E for each aircraft COL. A is generally based on operating costs and overhead costs for operating the aircraft COL. A. Operating costs and overhead costs may include, but are not limited to, costs for average fuel consumption, fuel additives, lubricants such as engine and transmission oil, maintenance labor and parts, engine and propeller restoration, flight expenses, crew expenses, insurance costs, hangar costs, and so on.

It should be understood, however, that it is not necessary for the costs per mile COL. E for each aircraft COL. A to be directly based on the operating and overhead costs. The costs per mile COL. E for each aircraft COL. A can also be a factor of these costs as long as the costs for all other aircraft COL. A are proportional. For instance, in the aircraft rate schedule 10 of FIG. 1, a C-310 aircraft ROW C has a cost per mile COL. E of $1.50 and a C-402 aircraft ROW D has a cost per mile of $2.10. The costs per mile COL. E for each of these aircraft COL. A could also be $15.00 and $21.00 respectively. In this manner, the costs per mile COL. E are maintained in the same proportion to one another, or simply, the same factor is used to generate new costs per mile COL. E. In the above instance, a factor of ten is used. Generally, smaller aircraft with lower airspeeds and lower load carrying capacities also have lower costs per mile.

Similar rate schedules can be created for other shipping services such as ground shipping by freight train. In such a case, the rate schedule would be determined by compiling a list of freight trains serially arranged by load carrying capacity, and so on.

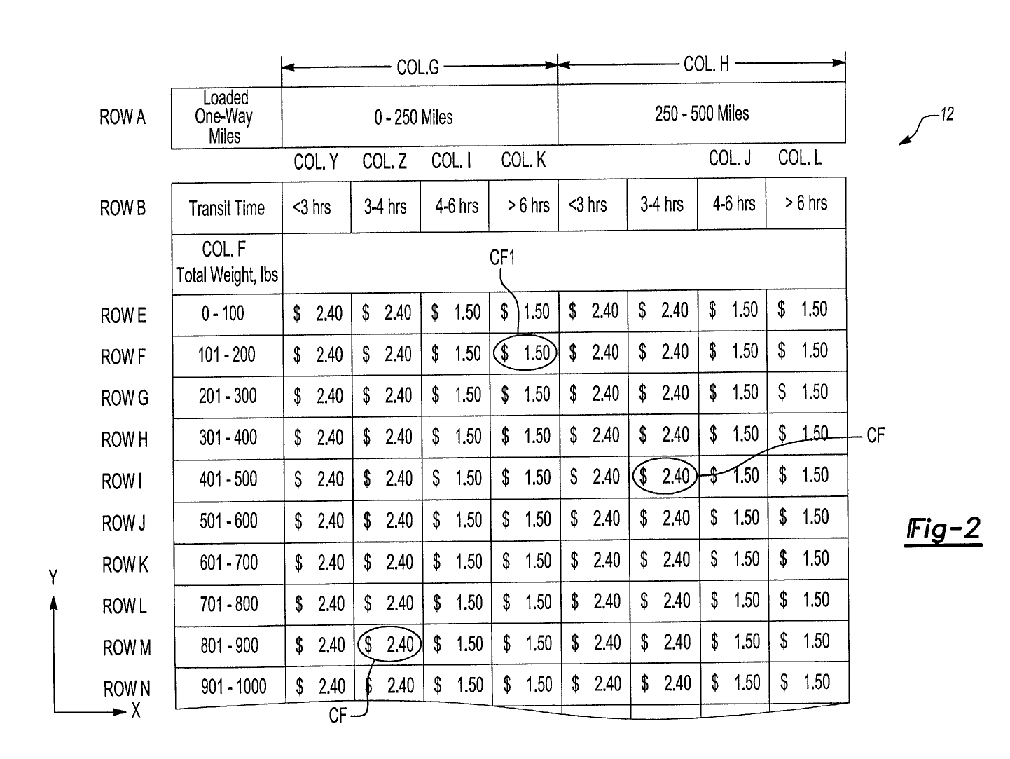

Referring to FIG. 2, a plurality of benchmark cost factors CF are compiled and arranged in a chart 12. The chart 12 includes a list of weight ranges COL. F along the X axis and distance ROW A and time ROW B along the Y axis. The list of weight ranges COL. F along the X axis is for the total weight of the goods to be shipped. The distance ROW A listed along the Y axis is the loaded one-way miles for the shipment. The time ROW B listed along the Y axis is the transit time or the actual time needed to ship the goods.

In the preferred embodiment, the chart 12 is prepared by using the lowest cost per mile from the aircraft COL. A on the aircraft rate schedule 12 that has a load capacity COL. B greater than or equal to the weight range COL. F on the X axis and an airspeed COL. C and range capable of falling within the loaded one-way miles ROW A and transit time ROW B on the Y axis. In other words, the lowest cost per mile COL. E for the aircraft COL. A from the aircraft rate schedule 10 that is capable of meeting the listed distance, time, and weight range constraints becomes the benchmark cost factor CF. It is to be understood that the chart 12 could also be prepared such that the highest cost per mile COL. E for the aircraft COL. A or an average cost is used as the benchmark cost factor CF. The manner in which the benchmark cost factors CF are determined is not intended to limit the present invention.

The C-310 aircraft ROW C has an airspeed COL. C of 200 miles per hour and a load capacity COL. B of 1000 lbs. The cost per mile COL. E of $1.50 for the C-310 aircraft ROW C is the lowest cost per mile on the aircraft rate schedule 10. Therefore, the cost of $1.50 is placed on the chart anywhere the weight range ROW E-ROW N is less than 1000 lbs. and the airspeed of 200 miles per hour is capable of meeting the transit time ROW B on the Y axis.

Flying at 200 miles per hour, the C-310 aircraft ROW C can make a 250 mile shipment in 1.25 hours. Intuitively, the $1.50 should be used for all transit time ranges greater than or equal to 1.25 hours and weight ranges ROW E-ROW N less than or equal to 1000 lbs., when the loaded one-way miles are 0-250 COL. G. However, referring to the chart 12, under the loaded one-way miles range of 0-250 COL. G and under the transit time ranges of less than 3 hours COL. Y and 3-4 hours COL. Z, a cost per mile of $2.40 is listed for all weight ranges ROW E-ROW F less than or equal to 1000 lbs. This is because the transit time ROW B ranges listed along the Y axis include 2 hours for pickup and delivery, therefore, the transit time ROW B range of 3-4 hours is 1-2 hours of flight time and 2 hours of pickup and delivery time. In other words, transit time equals flight time plus 2 hours. The C-310 aircraft ROW C is not capable of making any shipment within 3 hours, when 2 hours are required for pickup and delivery. At best, the C-310 aircraft ROW C can make the shipment within 3.25 hours, 1.25 hours for flight time and 2 hours for pickup and delivery. Therefore, the cost per mile COL. E of $1.50 for the C-310 aircraft is filled in the chart under the 0-250 loaded one-way miles ranges COL. G at transit time ROW B ranges of 4-6 hours COL. I and greater than 6 hours COL. K and for weight ranges ROW E-ROW N covering less than or equal to 1000 lbs. The present invention could also be practiced such that the transit time ROW B does not include 2 hours for pickup and delivery. In such a case, the benchmark cost factors are adjusted accordingly.

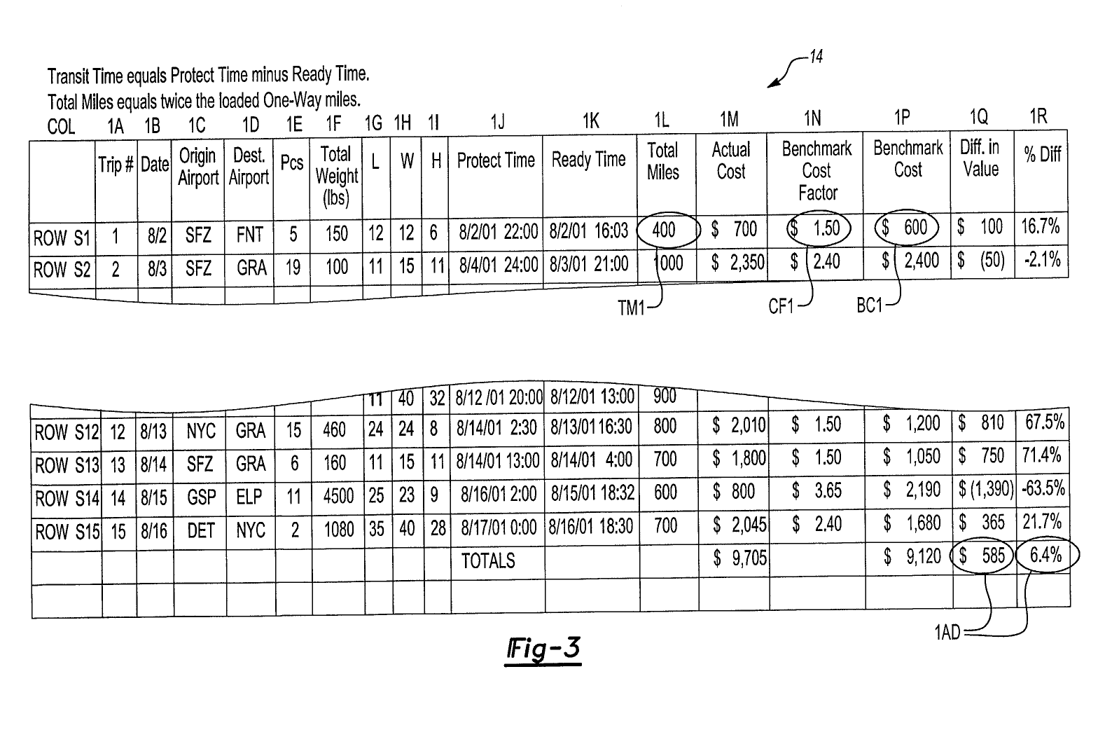

Data is compiled for each of the plurality of actual shipments ROW S1-ROW S15 by the first shipper, as shown in FIG. 3. Compiling data for the plurality of actual shipments ROW S1-ROW S15 by the first shipper includes compiling an actual cost COL. 1M, a total weight COL. 1F for the goods, a protect time COL. 1J and a ready time COL. 1K, a trip no. COL. 1A, a date COL. 1B, an origin and destination airport COL. 1C, COL. 1D, a number of pieces being shipped COL. 1E, dimensions of the pieces being shipped including length, width, and height COL. 1G-COL. 1I, and a total miles COL. 1L for each of the plurality of actual shipments. The data can be compiled in a first shipper chart 14, as shown in FIG. 3, using a computer or by hand.

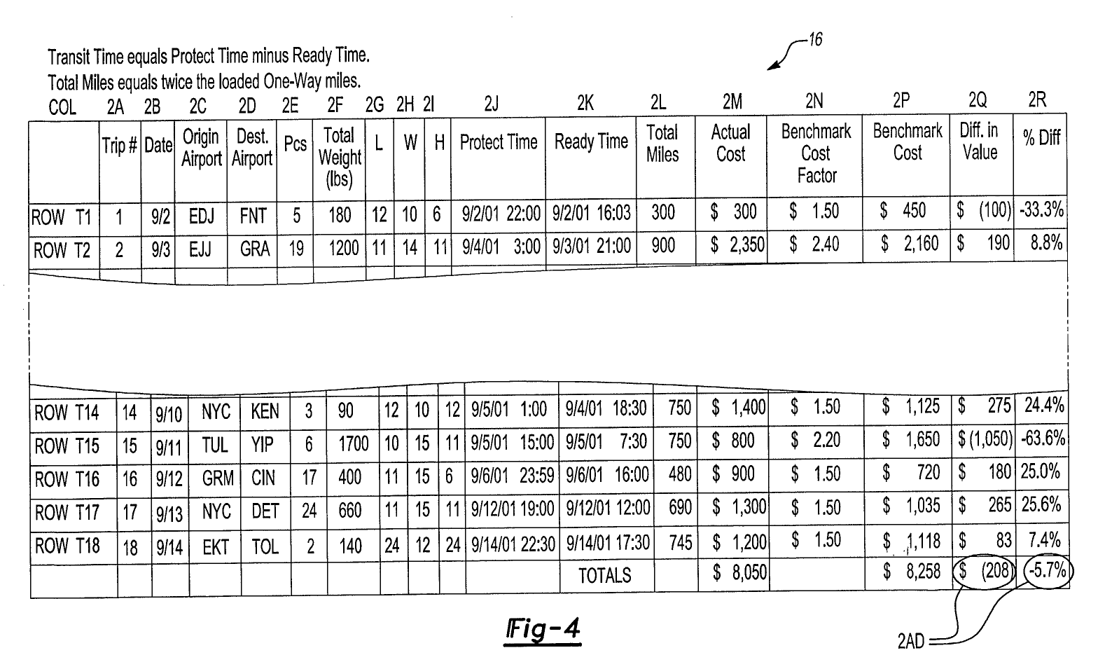

Data is compiled for the plurality of actual shipments ROW T1-TWO T18 by the second shipper. Compiling data for the plurality of actual shipments ROW T1-ROW T18 by the second shipper includes compiling an actual cost COL. 2M, a total weight COL. 2F for the goods, a protect time COL. 2J and a ready time COL. 2K, a trip no. COL. 2A, a date COL. 2B, an origin and destination airport COL. 2C, COL. 2D, a number of pieces being shipped COL. 2E, dimensions of the pieces being shipped including length, width, and height COL. 2G-COL. 2I, and a total miles COL. 2L for each of the plurality of actual shipments. The data can be compiled in a second shipper chart 16, as shown in FIG. 4, using a computer or by hand. It is to be understood, that additional data associated with each shipment by the first and second shippers could also be compiled. Such data may include weather conditions, fuel consumption, delays, landing and parking fees, and so on.

The benchmark cost factors CF that are used, are proportional to at least a portion of the data compiled for the first and second shippers. Furthermore, the benchmark cost factor COL. 1N, COL. 2N that is proportional to the actual shipment data that is compiled is used to determine a benchmark cost COL. 1P, COL. 2P for each shipment. The benchmark cost factor COL. 1N, COL. 2N is selected from the first and second shipper charts 14,16 based on the total weight COL. 1F, COL. 2F of the goods shipped during each shipment, the total miles COL. 1L, COL. 2L of the shipment, and the transit time. The transit time being the protect time COL. 1J, COL. 2J minus the ready time COL. 1K, COL. 2K.

For example, referring to the first shipment ROW S1 in FIG. 3, the loaded one-way miles are 200 miles (the loaded one-way miles are one-half the total miles or one-half of 400 for the first shipment ROW S1), the transit time is 5 hours and 57 minutes (transit time equals protect time minus ready time), and the total weight of the goods is 150 lbs. Therefore, the first benchmark cost factor CF1 from the chart 12, used for the first shipment ROW S1 falls under the loaded one-way miles range of 0-250 COL. G, the transit time range of 4-6 hours COL. I and the total weight range of 101-200 lbs ROW F. As a result, the first benchmark cost factor CF1 of $1.50 is used for the first shipment ROW S1. It is to be understood that other variables may be taken into account when selecting the benchmark cost factor for each shipment. Other factors may include the dimensions of the pieces being shipped. If the standard door of the aircraft is not large enough to accommodate the goods, an aircraft with a larger standard door will need to be used, therefore, a different benchmark cost factor may be employed based on the cost per mile of the aircraft with the larger door. Furthermore, the pickup and delivery time of 2 hours could be accounted for in the selection of the appropriate benchmark cost factor CF, as opposed to incorporating the 2 hours in the transit time.

The benchmark cost COL. 1P, COL. 2P for each shipment is determined by multiplying the benchmark cost factor CF by the total miles COL. 1L, COL. 2L for each shipment. Therefore, in the above example the first benchmark cost BC1 for the first shipment ROW S1 by the first shipper is $600. The first benchmark cost BC1 is determined by multiplying the first benchmark cost factor CF1 of $1.50 by the total miles TM1 for the first shipment ROW S1 of 400. The benchmark cost COLUMN 2P for each of the plurality of shipments ROW T1-ROW T18 by the second shipper is determined in the same manner, by multiplying the benchmark cost factor CF by the total miles COLUMN 2L for each shipment ROW T1-ROW T18.

A deviation COL. 1Q, COL. 2Q, COL. 1R, COL. 2R is determined between the actual cost COL. 1M, COL. 2M for each shipment and the benchmark cost COL. 1P, COL. 2P for each shipment for both the first and second shippers. Determining the deviation COL. 1Q, COL. 2Q, COL. 1R, COL. 2R between the actual cost COL. 1M, COL. 2M for each shipment and the benchmark cost COL. 1P, COL. 2P for each shipment includes subtracting the benchmark cost COL. 1P, COL. 2P from the actual cost COL. 1M, COL. 2M for each shipment by the first and second shippers to yield a difference in value COL. 1Q, COL. 2Q. Taken one step further, the deviation COL. 1Q, COL. 2Q, COL. 1R, COL. 2R is determined by subtracting the benchmark cost COL. 1P, COL. 2P from the actual cost COL. 1M, COL. 2M to determine the difference in value COL. 1Q, COL. 2Q and dividing the difference in value COL. 1Q, COL. 2Q by the benchmark cost COL. 1P, COL. 2P for each shipment by the first and second shippers to yield a percentage difference COL. 1R, COL. 2R.

The deviations COL. 1Q, COL. 2Q, COL. 1R, COL. 2R for the first and second shippers are summed to provide a first shipper average deviation 1AD and a second shipper average deviation 2AD. The first and second shipper average deviations 1AD,2AD can be the total of the differences in value COL. 1Q, COL. 2Q or the percentage differences COL. 1R, COL. 2R.

The average deviations 1AD,2AD are compared to determine which of the first and second shippers experienced the lowest shipping expense. In the first and second shipper charts 14,16 used to illustrate the preferred embodiment, the first shipper average deviation 1AD is 6.4% and the second shipper average deviation 2AD is −5.7%. Therefore, on average, the first shipper charges 6.4% above the benchmark cost COL. 1P, COL. 2P, and the second shipper charges, on average, 5.7% below the benchmark cost COL. 1P, COL. 2P.

The preferred embodiment of the subject invention is practiced using a proprietary spreadsheet package and computer to perform the necessary calculations and prepare the aircraft rate schedule 10, chart 12 and first and second shipper charts 14, 16. It is to be understood, however, that the present invention could also be practiced as a user-prompted software program. In this manner, the user enters the data for the plurality of shipments by the first and second shipper and the software program utilizes a predetermined aircraft rate schedule and chart to determine the benchmark cost factor for each shipment. The software program would then perform the calculations described above and print a report for the user showing the first and second shipper average deviations, much like those shown in FIGS. 3 and 4, to allow the user to determine which of the first and second shippers experienced the lowest shipping expense.

Obviously, many modifications and variations of the present invention are possible in light of the above teachings. The invention may be practiced otherwise than as specifically described within the scope of the appended claims.

What is claimed is:

1. A method of comparing the total cost for a plurality of actual shipments by a first shipper to the total cost for a plurality of actual shipments by a second shipper, said method comprising the steps of:
compiling data for the plurality of actual shipments by the first shipper including actual shipment cost,
compiling data for the plurality of actual shipments by the second shipper including actual shipment cost,
using a plurality of benchmark cost factors proportional to at least a portion of the data,
using the benchmark cost factor which is proportional to the actual shipment data to determine a benchmark cost for each shipment,
determining a deviation between the actual cost for each shipment and the benchmark cost for each shipment,
summing the deviations to provide a first shipper average deviation and a second shipper average deviation, and
comparing the average deviations to determine which of the first and second shippers experienced the lowest shipping expense.

2. The method as set forth in claim 1 wherein the step of compiling data for the plurality of actual shipments by the first shipper further includes the step of compiling a total weight for each of the plurality of actual shipments.

3. The method as set forth in claim 2 further including the step of compiling a transit time and a total miles for each of the plurality of shipments by the first shipper.

4. The method as set forth in claim 3 wherein the step of using the benchmark cost factor which is proportional to the actual shipment data to determine the benchmark cost for each shipment further includes the step of multiplying the benchmark cost factor by the total miles for each shipment to determine the benchmark cost for each shipment by the first shipper.

5. The method as set forth in claim 1 wherein the step of compiling data for the plurality of actual shipments by the second shipper further includes the step of compiling a total weight for each of the plurality of actual shipments.

6. The method as set forth in claim 5 further including the step of compiling a transit time and a total miles for each of the plurality of shipments by the second shipper.

7. The method as set forth in claim 6 wherein the step of using the benchmark cost factor which is proportional to the actual shipment data to determine the benchmark cost for each shipment further includes the step of multiplying the benchmark cost factor by the total miles for each shipment to determine the benchmark cost for each shipment by the second shipper.

8. The method as set forth in claim 1 further including the step of determining an aircraft rate schedule by using a list of aircraft serially arranged by load carrying capacity and including an airspeed and cost per mile, for each aircraft.

9. The method as set forth in claim 8 wherein the step of compiling a plurality of benchmark cost factors further includes the step of preparing a chart of benchmark cost factors having a list of weight ranges along the X axis and distance and time along the Y axis, filling in the chart with the lowest cost per mile from an aircraft on the aircraft rate schedule which has a load capacity falling the weight range on the X axis and an airspeed capable of falling within the distance and time on the Y axis.

10. The method as set forth in claim 1 wherein the step of determining the deviation between the actual cost for each shipment and the benchmark cost for each shipment further includes the step of subtracting the benchmark cost from the actual cost for each shipment by the first and second shippers to determine the deviation.

11. The method as set forth in claim 1 wherein the step of determining the deviation between the actual cost for each shipment and the benchmark cost for each shipment further includes the step of subtracting the benchmark cost from the actual cost to determine a difference in value and dividing the difference in value by the benchmark cost for each shipment to determine the deviation.

12. A method of comparing the total cost for a plurality of actual shipments by a first shipper to the total cost for a plurality of actual shipments by a second shipper, said method comprising the steps of:
determining an aircraft rate schedule by compiling a list of aircraft serially arranged by load carrying capacity and including an airspeed, a range and cost per mile, for each aircraft;
preparing a chart of benchmark cost factors having a list of weight ranges along the X axis and distance and time along the Y axis, filling in the chart with the lowest cost per mile from an aircraft on the aircraft rate schedule which has a load capacity falling in the weight range on the X axis and an airspeed and range capable of falling within the distance and time on the Y axis;
determining a deviation for a first shipper by comparing the actual cost for each shipment to a benchmark cost resulting from multiplying the benchmark cost factor by the miles of the shipment, the benchmark cost factor being under the range of time including the actual time of the shipment, and summing the deviations to determine a first shipper average deviation;
determining a deviation for a second shipper by comparing the actual cost for each shipment to a benchmark cost resulting from multiplying the benchmark cost factor by the miles of the shipment, the benchmark cost factor being under the range of time including the actual time of the shipment, and summing the deviations to determine a second shipper average deviation; and
comparing the average deviations to determine which of the first and second shippers experienced the lowest shipping expense.

13. A method of comparing the total cost for a plurality of actual shipments by a first shipper to the total cost for a plurality of actual shipments by a second shipper, said method comprising the steps of:
compiling data for the plurality of actual shipments by the first shipper including actual shipment cost,
compiling data for the plurality of actual shipments by the second shipper including actual shipment cost,
using a benchmark cost factor which is proportional to at least a portion of the actual shipment data to determine a benchmark cost for each shipment,
determining a deviation between the actual cost for each shipment and the benchmark cost for each shipment,
summing the deviations to provide a first shipper average deviation and a second shipper average deviation, and
comparing the average deviations to determine which of the first and second shippers experienced the lowest shipping expense.
